(19) United States
(12) Patent Application Publication
(10) Pub. No.: US 2012/0128475 A1
(43) Pub. Date: May 24, 2012

(54) Vortex Enhanced Wind Turbine Diffuser

(75) Inventor: Ralph-Peter Bailey, Wiston (GB)

(73) Assignee: KINETIC HARVEST LIMITED, Wiston, Steyning (GB)

(21) Appl. No.: 13/320,744

(22) PCT Filed: May 14, 2010
(86) PCT No.: PCT/GB10/50793

§ 371 Date: Feb. 13, 2012

(30) Foreign Application Priority Data
May 15, 2009 (GB) 0908355.1

(51) Int. Cl. F03D 11/00

(52) U.S. Cl. 415/182.1

(57) ABSTRACT

A diffuser for a wind turbine where slots in said diffuser wall entrain air to enter into the diffuser with a swirl that is counter to the internal swirl created as a reaction to the turbine blades rotation as it extracts power such that the internal swirl and the externally introduced swirl cross over each other thereby causing vortices to form between them that energizes the internal flow and helps to prevent it from separating from the internal duct wall. Such a diffuser would beneficially consist of a radial array of repeated segments each comprising a radial portion of a duct with a wing emerging from behind said duct leading edge and spiraling out and backwards and connecting back onto the wing of the next segment round such that each segment's wing connects to the trailing neighboring segment wing just as the leading neighbors wing connects onto it, and that a gap is left between the spiral arms to permit external air to flow between the trailing edge of one segment wing and the leading edge of the adjacent wing.

### FIELD OF THE INVENTION

The present application pertains to a novel compact diffuser for enhancing the pressure differential across a turbine blade set to thereby extract more power for a given turbine diameter.

The present invention relates to the use of an aerodynamic cowling that entrains air flow into a duct, increasing the pressure ahead of the turbine blades and a diffuser to generate low pressure behind the turbine blades, thereby increasing the pressure differential. Such a device is optimized for effectiveness at a minimum size and to achieve maximum robustness.

### BACKGROUND OF THE INVENTION

Diffuser Augmented Wind Turbines (DAWTs) are well known and understood. They first emerged in the 1970s when several patents were granted for both small and large scale devices.

A diffuser will accelerate the wind through the turbine, and as power is proportional to wind speed cubed, the use of a diffuser enables smaller diameter blades to achieve the same power yield. It also has collateral benefits in being quieter than open rotors (no blade tip vortex), is considered safer for wildlife (having a more visible boundary) and will perform better in turbulent conditions (wind tends to flow more axially through a duct). Collateral cost benefits stem from the smaller lower stressed blades that can be made by lower cost processes and the higher turbine speeds which enable smaller, lighter and lower cost electrical generators. A diffuser's viability thus depends upon its net cost being less than otherwise increasing the diameter of a conventional open rotor turbine to achieve the same power.

Early diffuser designs had a duct behind the blades that flared open like the end of a trumpet. They work by two means—the flow is caused to increase its cross sectional area causing back suction as its momentum is lost, and faster external wind flowing past the rim of the diffuser sucks internal flow into it by virtue of the venturi effect.

A challenge with diffuser design is to avoid flow separation as the expanding air stream follows the internal wall of the diffuser. Such separation generates turbulence that compromises the pressure drop. Various devices have been proposed to control this degrading effect.

In U.S. Pat. No. 4,075,500 holes 34 allow external air to flow in and enter the shroud downstream of the turbine blades which energizes the boundary layer and keeps it from separating along the inner wall of the diffuser. U.S. Pat. No. 4,132,499 shows more complex internal passages to collect and distribute air from the outside of a duct and deliver it to the inside of the duct to achieve a similar effect. U.S. Pat. No. 4,422,820 shows spoiler grooves which also collect and distribute air from the outside of a duct and deliver it to the inside of the duct to energize the boundary layer. A potential problem with these holes though is increased cost to manufacture while the potential for fouling and loss of function with time is increased.

U.S. Pat. No. 4,132,499 also shows a secondary circular wing at the downstream side of the diffuser which helps create a greater pressure drop across the turbine with a shorter overall length of the diffuser system. The secondary wing concept is taken to the next step in U.S. Pat. No. 5,324,985, where it is made in sections that are angularly controllable. Slots between sections of the duct help to energize the boundary layer with external high speed air. U.S. Pat. No. 7,018,166 uses a free-spinning rotor downstream of the wind turbine to also more actively control flow to reduce separation. U.S. Pat. No. 7,094,018 uses an arcuate shape diffuser to attempt to also better control the flow.

In all cases the object remains the same—to provide a more cost effective means of harnessing the wind's kinetic energy.

### OBJECTS OF THE INVENTION

A principal object of this invention, therefore, is to provide a diffuser design for a wind turbine that generates a high degree of flow augmentation.

A further object of this invention is to make the diffuser as small as possible consistent with the first object.

A further object of this invention is to make the diffuser as robust as possible consistent with the first two objects.

A further object of this invention is for the diffuser to be able to be manufactured from low cost materials using low cost processes.

A further object of this invention is to compensate for the deleterious effects of the mounting means and tower by employing a further wing type device to induce additional compensating air flow.

A further object of this invention is to mount such a turbine within a gimbal that enables horizontal as well as vertical axis alignment.

A further object of this invention is to mount turbines in pairs with a horizontal tilt axis coupling them such that they can align both vertically and slew horizontally.

Other and further objects will be explained hereinafter and more particularly delineated in the appended claims.

### SUMMARY OF THE INVENTION

In summary the invention proposes a new style of diffuser that accelerates and focuses the wind through the turbine in order to extract more power per unit cross sectional area for a given wind speed. The diffuser features are aimed at reducing its length and volume as far as possible without significantly degrading the performance, as the object is to optimize cost effectiveness not to achieve the ultimate flow augmentation performance. This is achieved by a superior regime of boundary layer control that enables the internal flow to be expanded at a steeper cone angle than hitherto possible without suffering the flow separation that would otherwise compromise the diffusers effectiveness.

Whereas prior art teaches us that introducing high energy external flow into the low energy internal flow is an effective technique to achieve boundary layer control, a conventional diffuser would typically be about twice as long as its internal duct diameter. This invention enables the diffuser length to be reduced to about half the duct diameter and thereby has a significantly lower production cost. Also the size of a diffuser determines its wind loading which being proportional to the cube of the wind speed becomes an issue in overload wind conditions. A diffuser needs to be able to survive a rare 120 mph storm, which will have about 600 times the power of an average 15 mph wind. This introduces a significant cost premium to make the diffuser and its support structure sufficiently robust, therefore reducing the diffusers volume by a factor of 4 will have a commensurately large cost benefit.

Prior art has also introduced the idea of splitting the diffuser into a nested series of frusto conical rings retained such that there are radial gaps between the trailing edge of an inner ring and the leading edge of the next outer ring. This has construction issues as the reduced chord of the diffuser rings also reduces their thickness and hence strength, and yet they must be attached in a sufficiently robust way to sustain the requisite peak loads. Solving this loading issue would entail radial arrays of connection pylons which would then act to spoil the clean flow of injected air.

This invention proposes a diffuser comprising of a radial array of spiral winglets extending upwards and behind the segmented leading edge. The spiral direction follows the rotation direction of the turbine blades and is therefore counter to the swirl direction of the air passing through the blades such that the winglet leading edge is approximately normal to the internal local flow direction. This arrangement has the following advantages.

The diffuser is constructed by repeating a common radial segment. This reduces the tooling cost and the number of different parts required.

The diffuser segments are readily coupled and feature a thick root that promotes robustness and which can accommodate a reinforcing framework on large scale devices. Segments are coupled in four places, radially clockwise and counter clockwise to adjacent segments from the leading edge and at the diffuser wing tips such that the segments wing tip terminates on the adjacent segments wing just as the other adjacent segments wing tip terminates on its own wing. The resulting structure has no loose ends, no pylons and a cross linked coupling that promotes stiffness.

Segments may advantageously be constructed by the rotational moulding process which can provide a seam free hollow shell of complex form in a tough low cost plastic like polythene. Such hollow parts may then be foam filled for improved stiffness. The rotational moulding process also permits reinforcing members to be introduced into the tool and effectively moulded in.

As the wind passes through the turbine it is deflected by the turbine blades and thereby acquires a swirl. It is possible to recover some of the swirl energy by utilizing a second counter rotating turbine or fixed stator blades that deflect the swirling air back into a more axial path, but this adds significantly to the cost.

The swirl angle has the effect of extending the length of the flow path within the diffuser and so is equivalent to increasing its length. The swirl angle could typically be ˜20 degrees. This is an issue with diffusers that employ convolutions to improve the mixing of internal and external flow as the axis of the convolutions cannot simultaneously by optimum for the axial external flow and the swirling internal flow.

In this invention, the swirl is utilized in two ways. Firstly the diffuser is designed to cooperate with the swirl such that the internal flow is bisected by the maximum number of spiral diffuser wing elements, each largely normal to the flow direction in order to provide for several injections of high energy external flow. Secondly the external flow enters the diffuser with a counter swirl bias (see below) on the outside of the swirling inner flow, which then causes a wind shear effect at their interface. This induces vortices that follow the inner surface of the diffuser and act to enhance the mixing of low and high energy flows and thereby helps the flow to expand out with reduced risk of flow separation—much like the effect of vortex generators on the upper surface of aircraft wings which extend the permissible angle of attack before wing stall (flow separation).

The external flow is influenced by the spiral pressure dam effect of the winglets leading edge trying to compress and accelerate the flow between it and the lower trailing edge. This has the effect of generating a swirl counter to the internal swirl. Where these two layers come into contact they cause vortices to be formed (the same mechanism that creates tornados). This rapidly energises the internal flow enhancing its suction effect. The reduced pressure also holds the flow against the duct wall without flow separation even though the KH duct is much steeper (shorter).

A shorter more compact diffuser is clearly lower cost and less vulnerable in storm conditions. Because the leading edges on the diffuser winglets sweep back in their spiral path there are no flow normal surfaces that would generate pressure peaks with the consequential increased drag. The greater the flow speed the lower the pressure will be in the diffuser, increasing the pressure differential across the turbine and hence its power.

Various devices may be employed to further enhance the flow control.

The trailing edges may be convoluted generally in the plane of their surfaces to increase the edge length and thereby mitigate the pressure shock as the outer and inner flow streams come together and intersect. Biasing these convolutions such as introducing a twist will act so as to trip the vortex generation at the preferred pitch.

Features like tubercles could also be added to the leading edges to again induce vortex generation.

A radial array of vortex generators can be added to reduce the risk of flow separation in the zone immediately behind the blades before the first slots are encountered. These may beneficially be of a style that lend themselves to be moulded into the surface of the diffuser without causing the molding complication of undercuts. The vortex generators are beneficially arranged such that the direction of rotation of the vortices is the same as that caused further up where the high energy flow passes through the slots with a swirl and also generates vortices as it crosses the counter swirl generated by the blades.

Similarly a further radial array of vortex generators may be included into the nacelle molding behind the root of the blades. Here they will help to avoid the flow separating as it is expanded in order to fill the space behind the nacelle.

Where the flow enters the slots it must turn in order to flow along the duct inner surface. In order to ensure this occurs without flow separation an array of small turbulator features like a raised or depressed zigzag man cause a turbulent boundary layer to be formed which reduces the local pressure and helps to maintain the flow without it becoming fully turbulent.

A preferred means to mount the diffuser onto a tower is to extend 6 struts downwards in an octahedral arrangement from reinforced hard points on the diffuser segments or its internal truss type framework onto the tower turntable. However the turntable and mounting struts will cause additional drag and turbulence and thereby reduce the flow speed locally leaving the turbine with an unbalanced velocity profile. This effect can be mitigated by introducing a further winglet mounted on the turntable with an inverted aerofoil so as to enhance the flow between it and the main diffuser and thereby compensate for the otherwise negative effect.

A set of radial spokes can be employed to support the turbine power pod within the diffuser. This has the collateral benefit of establishing and holding the roundness of the duct as the spokes are appropriately tensioned. If the spokes are made from pulltruded carbon or glass fibre, they can be profiled like an aerofoil in order to reduce their drag and tendency to generate turbulence. Fibre reinforced plastics have natural self damping qualities which would inhibit rotor born vibration from resonating the diffuser or its support tower. An ideal arrangement would utilize two spokes per segment. The total drag of the spokes array will be significantly less than an equivalent single pillar support.

The diffuser may optionally include an integrated set of stator blades that can also serve to support the central nacelle rather than a separate spokes arrangement.

In the preferred embodiment the stator is upstream. By swirling the air before it hits the blades, it rotates their lift vector so that more power can be extracted as rotation rather than merely causing axial drag.

Unlike conventional radial stators, the blades may be formed into a spiral so that any trailing edge turbulence does not hit the rotating blades in a single wave front but impacts more gently as the blade/stator intersection moves from root to tip.

The stator may also beneficially extend out in front of the diffuser leading edge. As such it helps to entrain air into the duct and also provides more length to further align off axis wind.

The hub may be proportionately larger than typical on open rotor turbines. This moves the air from the centre where the otherwise low blade speed prevents efficient power extraction to the more productive blade tip area. The design does not require the nose cone to spin so unlike a large ‘spinner’ does not generate a lot of skin friction.

Instead of a single tubular tower to mount the turbine, better material utilization is achieved by using a tripod arrangement. This is because the tripod's mass is further displaced from the tower's neutral axis than would be the case with a tube. With an optimized design for a given loading this would consequently result in reduced material usage and hence cost.

By connecting the tripod bases with three further tubular members other collateral benefits can be enjoyed. The frame becomes fully constrained and stiff as it now describes a tetrahedron. One of the ground members can be nominated to act as a pivot axis which is then retained against the ground using ground anchors. The vertex of the two struts attached to this pivot can then act like the peak of an “A” frame in providing a levered means to raise and lower the tower without requiring large temporary on site lifting equipment. The vertex point is simply uncoupled from its ground anchor retained pad, and a winch employed to effect the raising or lowering.

A big advantage of this arrangement is that no special foundations with large volumes of buried concrete are required for the tower. The tetrahedral tower is essentially stable in its own right and only requires appropriate ground anchors to hold it down.

It may be desirable to site turbines at topographical terrain features such as cuttings between hills that act as natural flow augmentation devices in that they locally accelerate the wind speed. A consequence could be that the turbine will have to work in rising air streams. With the large diameter blade sets of conventional turbines it is not practical to incline their towers to provide tilting clearance, so either these otherwise advantageous sites cannot be exploited or the turbine rotor will perform inefficiently as the rising blade has a smaller angle of attack compared to the falling blade. This changing lift will flex the blades during each revolution which will increase their loading and reduce their life.

A turbine housed in a diffuser could be supported by a gimbal such that it can orientate itself to be axial to the wind direction in 3 dimensions. This restores balance to the turbine even when sited on steep gradients. Such a gimbal would advantageously have its “U” frame profiled as an inverted aerofoil so that it can act like a further external radial wing in entraining additional wind into the diffuser region in order to compensate for any otherwise deleterious aerodynamic effects.

The turbines could be mounted as a pair with a common horizontal pivot axis as well as the vertical slewing axis. This embodiment has two particular advantages:
The twin unit produces a greater slewing torque which enables it to track horizontal wind shifts more rapidly.
By being able to tilt vertically it can better utilise the rising wind streams you would find on hills and escarpments, precisely where the wind is the strongest.

This is very significant as a rising wind is very difficult for a conventional turbine to handle. The rising blade would suffer a much increased angle of attack and being in semi stall would cause high drag, whereas the falling blade looses its angle of attack and lift. Not only is this inefficient but it also stresses the blades and bearings with the pulsing loads during each revolution.

Best mode and preferred designs and techniques will now be described with reference to the appended drawings.

### BRIEF DESCRIPTION OF THE DRAWINGS

The present invention can best be understood in conjunction with the accompanying drawings in which:

FIG. 1 shows a radial array of segments illustrated by way of cross sections at 5-degree intervals.

FIG. 2 shows the same diffuser from the side and from the front.

FIG. 3 shows a diffuser with wavy trailing edge mounted on a tower turntable with a winglet that compensates for the loss of efficiency caused by the mounting means.

FIG. 4 shows a reinforcing framework which can be embedded within the segments and the spokes that can be employed to support the turbine power pod.

FIG. 5 shows a diffuser shrouded turbine mounted by way of a gimbal onto a tower such that it can tilt to become normal to rising wind flow.

FIG. 6 shows a sectional view through the diffuser illustrating the flow paths from the side and from the top.

FIG. 7 shows a segment of a different embodiment of a diffuser with integrated forward mounted stator blades supporting the centrally mounted generator.

FIG. 8 shows the same diffuser embodiment from the rear and featuring a radial array of vortex generating elements.

FIG. 9 shows an embodiment of a central nacelle with blade set and stabilizing spokes, also with a radial array of vortex generating elements.

FIG. 10 shows a twin diffuser unit mounted with a coupling horizontal axis enabling vertical tilt as well as the usual vertical slewing axis.

### PREFERRED EMBODIMENTS

In the drawings, preferred embodiments of the invention are illustrated by way of example. The description and drawings are only for the purpose of illustration and preferred designs, and are not intended as a definition of the limits of the invention.

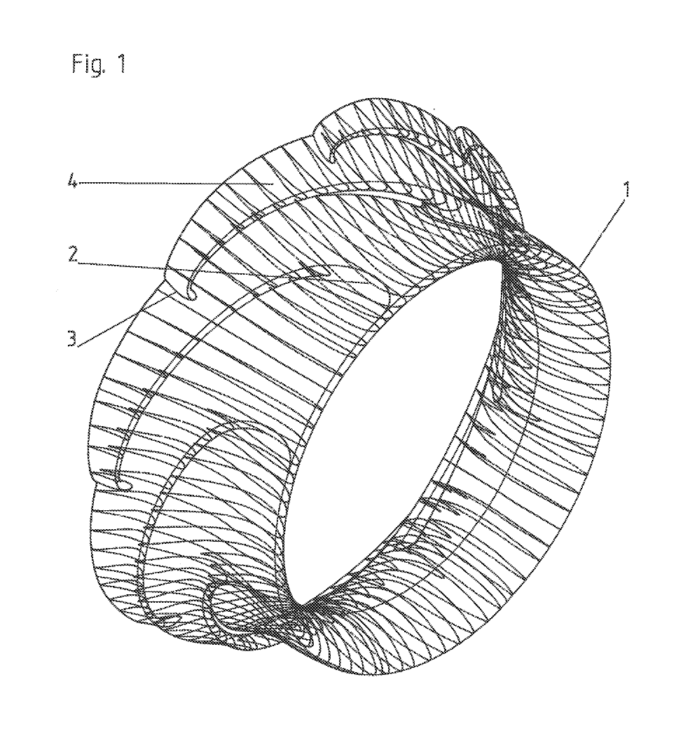

In FIG. 1

An embodiment of the invention is shown where the duct leading edge (1) blends radially with an increasing chord and thickness up to the transition point (2) where the winglet (4) breaks away to extend out and back until it can attach to the neighboring winglet (3).

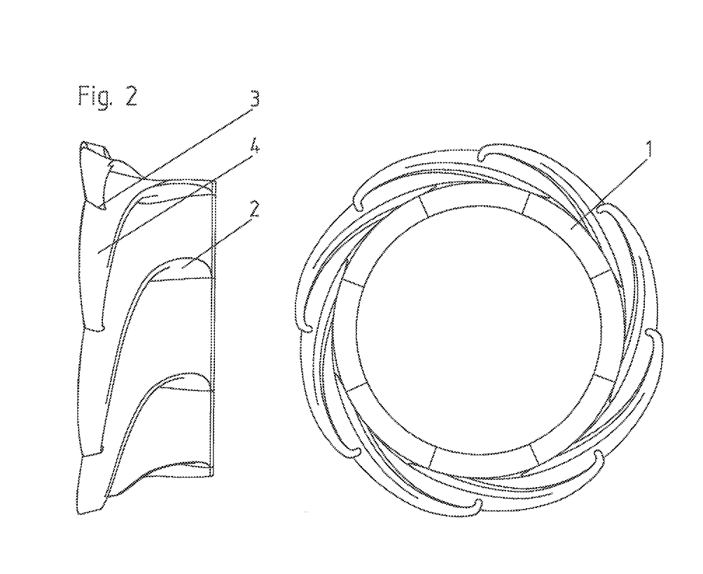

In FIG. 2

The same embodiment is shown at a side elevation and a front elevation illustrating where the segments join.

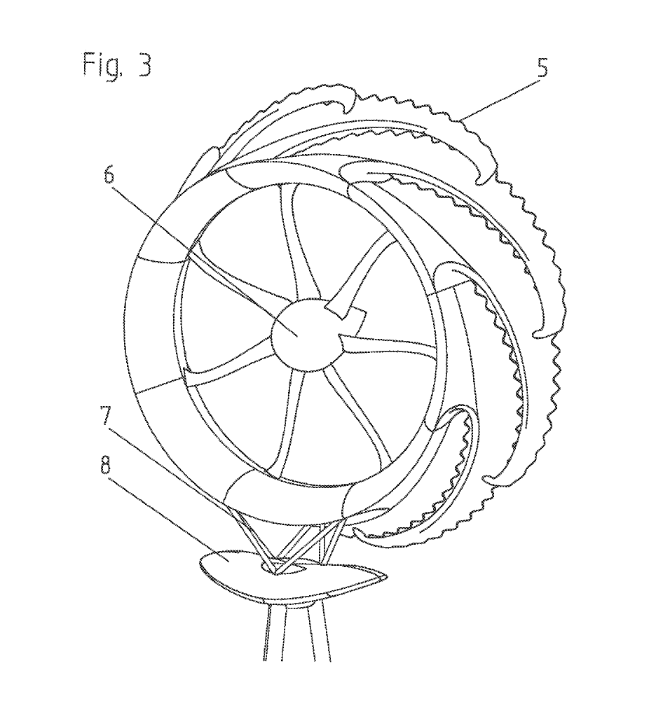

In FIG. 3

An embodiment with a convoluted trailing edge (5) is shown that acts to promote the mixing of low and high energy flow through the venturi effect. The power pod (6) is mounted in the centre of the duct, with external struts e.g. (7) connecting to the segments to provide a rigid mounting means to the turntable and tripod. A further winglet (8) with an inverted aerofoil entrains more flow in the gap between itself and the diffuser and thereby cancels out the reduction in flow speed caused by the mounting hardware.

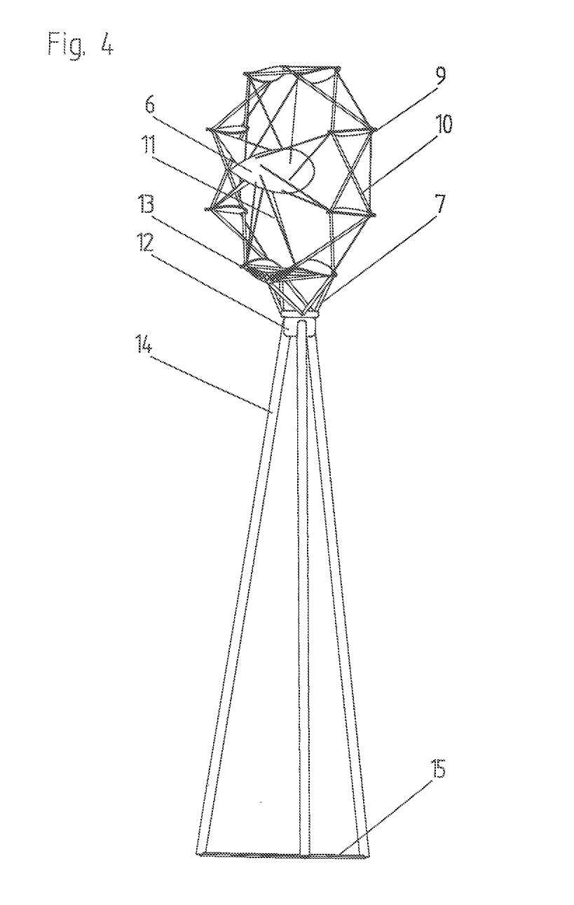

In FIG. 4

A reinforcing scheme is illustrated where formers (9) are fitted into the end faces of the segments with location means between them. Compression members (10) are stabilized by a tie rod or cable along the front edge, with spokes (11) pulling the segments in towards the turbine generator pod (6). The forward and aft spoke sets on the pod (6) could be attached to common rings such that by rotating at least one of the rings in the pod axis the entire array of spokes is simultaneously tensioned.

Where the mounting frame (7) attaches to the segments one or more additional formers (13) or frame members can be provided in order to increase the strength at this critical juncture. The mounting frame then attaches to the turntable (12) which also retains the tripod legs (14) that couple at their ends with further frame members (15) in order to create a stiff tetrahedral frame architecture.

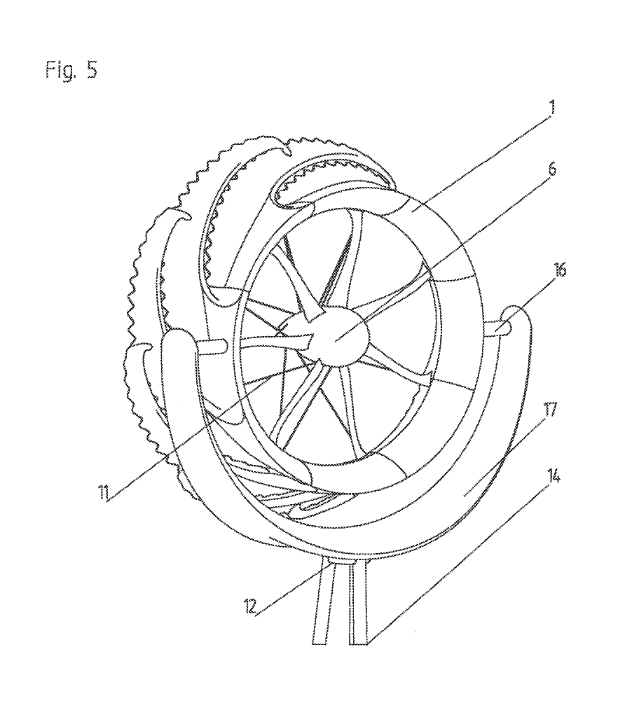

In FIG. 5

A different mounting scheme is illustrated where the duct (1) is stiffened by the spokes (11) which in turn retain the turbine pod (6) as before. However in this embodiment pivots (16) hold the entire assembly into the gimbal frame (17) being formed like a “U” shaped winglet with an inverted aerofoil in order for it to compensate for the parasitic drag arising from its own presence in the air stream.

The gimbal is then attached to the tripod tower (14) through the turntable (12).

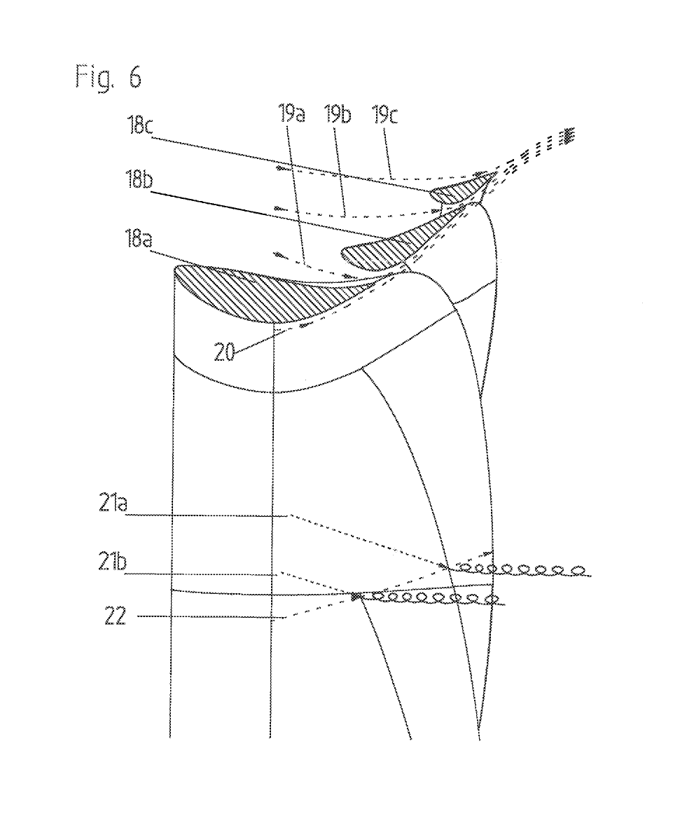

In FIG. 6

A cross section through the diffuser is shown revealing in this case the three tiers of wing (18a), (18b) and (18c) separated to permit the ingress of high energy external air along representative paths (19a), (19b) and (19c). The high energy air accelerates the expanding decelerating internal air shown by a representative path (20). This reduces the local pressure helping to hold the flow against the inside of the diffuser.

In the orthogonal plane the internal flow can be seem swirling around by the representative path (22) and the injected air with a counter swirl by paths (21a) and (21b) such that as the streams pass over each other they create a shear effect that generates small vortices. These vortices serve both to mix the high and low energy streams and hold them against the inside wall of the diffuser, again enabling the flow to expand out at a greater rate than possible with a smooth diffuser and hence considerable shortening it.

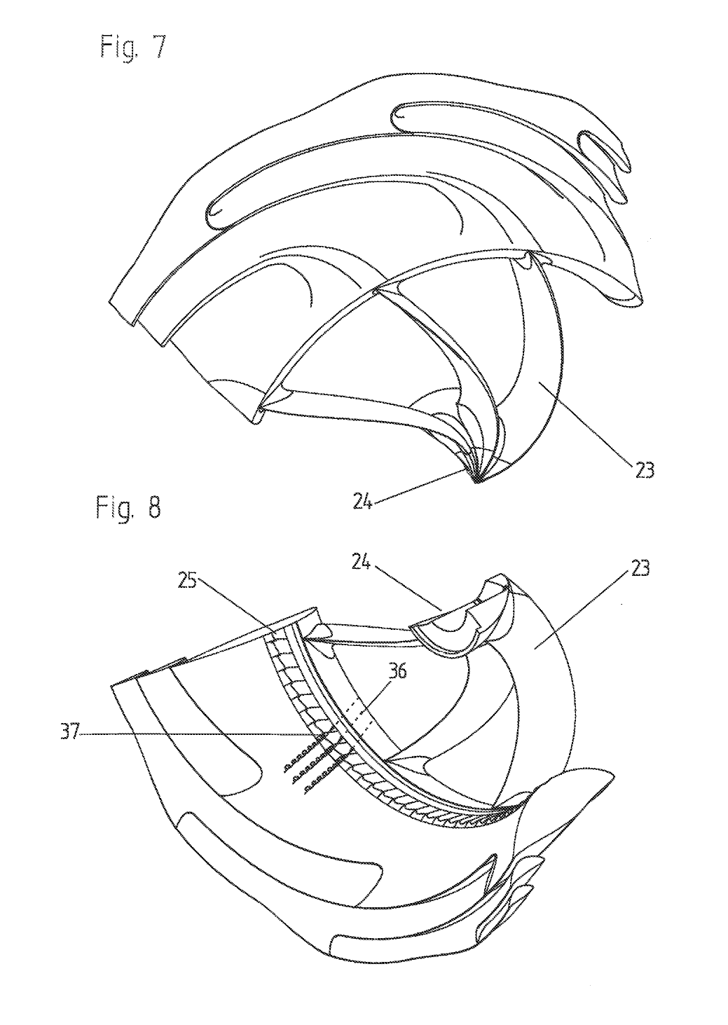

In FIG. 7

A 120-degree diffuser segment is shown with integrated spiral extending stator blades (23) leading to the hub segment (24).

In FIG. 8

The reverse of the same diffuser segment is shown from the back, with a segment of the housing for the generator shown (24) and the optional radial array of vortex generator features (25). Representative vectors showing the flow passing through the diffuser with a clockwise swirl angle (36) (as seen from the front of the diffuser) trip over the vortex generators which generate anticlockwise vortices as illustrated by (37).

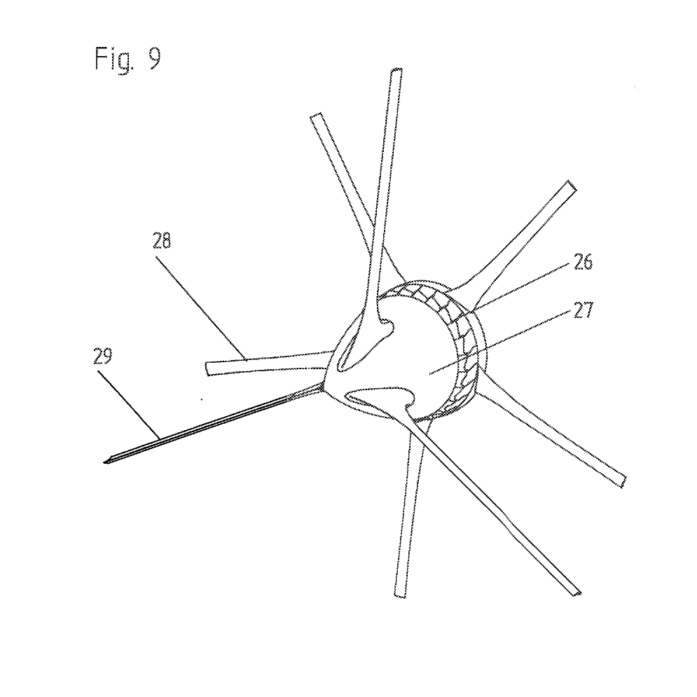

The vortex generating features are shaped like crescent ridges such that the arc of the crescent has its greatest angle of attack to the flow at its front and that the crescent is deepest near its centre and with a shallow ramp into the flow and a steep precipice trailing behind it. They may be deployed in a radial array on the inside of an expanding diameter surface of revolution as in FIG. 8 or on the outside of a reducing diameter surface of revolution as shown in FIG. 9 such that the feature does not present any undercuts in the axis of such surface and so can be molded into the diffuser surface without tooling complication.

In FIG. 9

The back portion of the central hub (27) is shown with turbine blades e.g. (28) and stabilizing spokes e.g. (29) that connect the back of the nacelle to the back of the inside of the diffuser.

Also shown is a further radial array of vortex generator features (26) which help to suck the flow against the tapering away back surface of the nacelle.

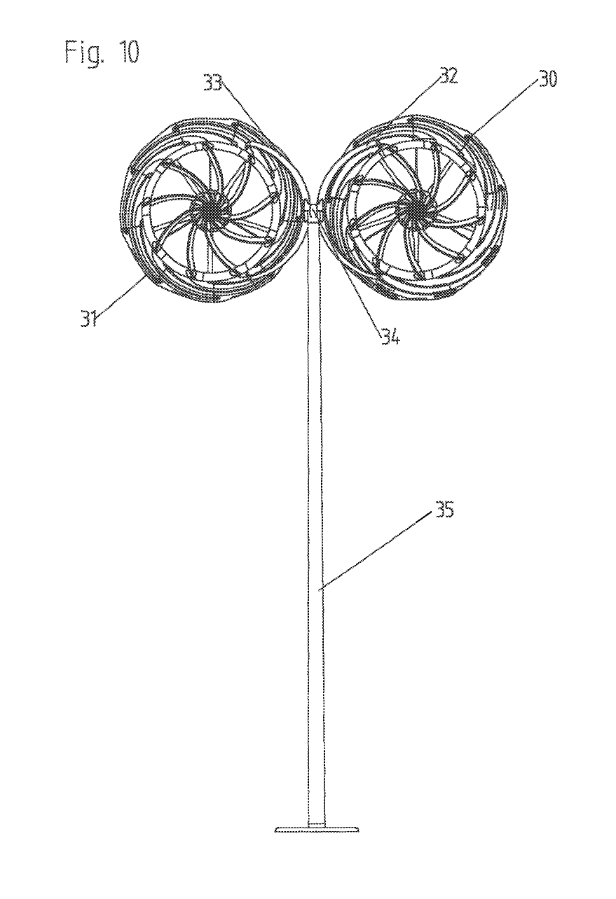

In FIG. 10

A twin unit wind turbine is shown with diffuser augmented wind turbines (30) and (31) connected to a horizontal pivot (34) by supports (32) and (33). A vertical slewing bearing then connects the horizontal pivot (34) to the vertical tower (35).

Further modifications of the invention will also occur to persons skilled in the art, and all such are deemed to fall within the spirit and scope of the invention as defined by the appended claims.

1. A diffuser for a wind turbine where slots in said diffuser wall entrain high energy external air to enter into the diffuser with a swirl that is counter to the internal swirl created as a reaction to the turbine blades rotation as it extracts power such that the internal swirl and the externally introduced swirl cross over each other thereby causing vortices to form between them that energizes the internal flow and helps to prevent it from separating from the internal duct wall.

2-17. (canceled)
